(19) United States
(12) Patent Application Publication
(10) Pub. No.: US 2005/0102704 A1
(43) Pub. Date: May 12, 2005

(54) Multiregional security system integrated with digital video recording and archiving

(76) Inventors: Rudy Prokupets, Rochester, NY (US); Michael Regelski, Rochester, NY (US)

Correspondence Address: Kenneth J. LuKacher, Esq.;South Winton Court, Suite 204, 3136 Winton Road South, Rochester, NY, 14623, US

(21) Appl. No.: 10/704,000

(22) Filed: Nov. 7, 2003

(51) Int. Cl. H04N 7/173

(52) U.S. Cl. 725/118; 725/105; 725/116; 725/114

(57) ABSTRACT

A security system is provided in multiple geographic regions having a master server with a master database storing information for access control in each of the regions, and each region has an access control system having a regional server with a regional database storing information for access control in the region, one or more cameras for capturing video data, and one more digital video recorders for storing video data from the cameras. In each region, the regional server receives events from one of the access control system, or other systems which may be present in the region, such as intrusion detection systems, fire systems, or information systems. When received event data is linked in the regional database to a camera in the region, the regional server generates a record to store event video information in the regional database having data representative of the event, the camera linked to the event, the digital video recorder storing video data from the linked camera, and date and time information related to a period of time over which the event occurred. At the regional level, one or more regional video archive servers are provided in each region for archiving video data from the region's digital video recorders. At the master level, a master video archive server is coupled to the master server for archiving video data from the regional video archive servers. If a regional video archive server is not present in a region, video data may be archived from the region's digital video recorders to the master video archive server via the master server. If the video data archived at the regional or master level is associated with event video information stored in a regional database, such event video information is updated to include data representative of the video archive server containing the video data related to the events and the file names under which such video data related to the events are stored on that video archive server.

### FIELD OF THE INVENTION

The present invention relates to a system (and method) for security access control over multiple geographic regions, where each region has cameras for capturing video in areas of one or more buildings, and relates particularly to, a system for security access control over multiple geographic regions, where each region has cameras for capturing video and captured video data recorded in each region is archived at a regional level, and then archived at a master level of the system. The invention is especially useful for maintaining archives of video captured in each region, and for linking video to events occurring in each of the regions to enhance security in each region and in the overall multiregional security system. Such events may represent potential security risk and occur in one or more of an access control system, intrusion detection system, fire system, or information system, which may be present in each region.

### BACKGROUND OF THE INVENTION

Conventional access control systems provide security to areas of buildings by utilizing readers associated with locking mechanisms to doors which control entry to such areas. Persons, such as employees, are provided with security badges having data accessible by the reader. Access decisions are made in accordance with security information stored at a central database in response to badge data read from the readers with or without a keypad entered pin number, or access decisions may be made by distributed databases associated with the readers. Examples of prior access control systems are described in U.S. Pat. Nos. 4,839,640 and 4,218,690. Such access control systems may operate in multiple different geographic regions, such as cities, states, or countries, such as described in U.S. Pat. No. 6,233,588. OnGuard® is a security system available from Lenel Systems International, Inc. of Rochester, N.Y. for enabling access control in multiple regions.

Video recording and monitoring systems are often also provided in buildings to protect assets or enable remote viewing of building areas. These video cameras store their video image data on digital or analog video recorders. These video recording and monitoring systems are conventionally separate from other facility protection systems, such as access control systems or intrusion detection or fire systems. As a result, events which pose possible security risk in such facility protection systems that occur in areas having video cameras are not linked to video data captured by such cameras. For example, a security badge used at a card reader of an access control system may be an event in view of a camera, and video image data from such camera can be invaluable in assessing whether badge was used by an unauthorized person. However since such events are not automatically linked to video data, security personnel must manually associate which cameras may have video data relevant for the event, which can be both time consuming and prone to human error. Moreover, so many events occur in facility protection systems each day that without means to associate which camera may have video data for which events, important video based information to evaluate security risk can be lost, or otherwise difficult to locate and access quickly.

Another problem is that the amount of video data on a video recorder stored from connected cameras is limited by the storage capacity of the video recorder, thereby providing recording of video data over a limited time period, such as a number of days or hours. Once the data storage of a digital video recorder is exceeded, earlier captured video data may be overwritten and hence lost, unless, for example, it is stored on a removable media (e.g., disk or tape) and timely replaced in the video recorder before being overwritten. Thus, it would be desirable to automatically archive video data for longer storage periods to avoid risk of losing potentially valuable video-based information. A further problem is in a multiregional security system, it would be desirable if video image data from multiple regions can be stored in a single repository of video data, such that it makes possible central management of security over all the regions utilizing video data captured in each of the regions.

### SUMMARY OF THE INVENTION

It is an object of the present invention to provide a security system in multiple regions in which video data captured in each region may be recorded and archived at a regional level, and later archived at a master level, or archived directly to the master level if regional archival is not available.

It is further object of the present invention to provide a security system in multiple regions in which in each region events from one of an access control system, or other systems which may be present in the region, such as intrusion detection systems, fire systems, or information systems, are automatically linked to video captured by cameras in the region.

It is another object of the present invention to provide a security system in multiple regions in which at each archival level video stored can be filtered for relevant video information related to events occurring in each of the regions.

Briefly described, the security system is provided in multiple geographic regions having at a master level, a master server with a master database storing information for access control in each of the regions, and at a regional level each region has an access control system having a regional server with a regional database storing information for access control in the region, one or more cameras for capturing video (image) data, where such cameras are situated in or around areas of buildings in the region, and one more digital video recorders for storing video data from a group of one or more of the cameras. In each region, the regional server receives event data from one of the access control system, or other facility protection systems which may be present in the region (such as intrusion detection systems or fire systems), or information (network-based) system(s) which may be present in the region, describing events which occur in such system(s) or a component thereof. For each event received, the regional server stores event information (e.g., in a record in an EVENT Table in the regional database). The regional database contains linkage information (e.g., in records of a VIDEO EVENT Table and CCTVDEVICE Table) defining the cameras and associated digital video recorders to be linked to different events in the region. When received event data describes an event linked to a camera in the region in accordance with the linkage information stored in the regional database, the regional server generates and stores event video information in the regional database (e.g., a record in a EVENT VIDEO Table) having data at least representative of the event, the camera linked to the event, the digital video recorder storing video data from the linked camera, and date and time information related to a period of time over which the event occurred.

At the regional level, at least one regional video archive server is provided in each region for archiving video data from the region's digital video recorders into memory storage of the regional video archive server when any of the digital video recorders in the region exceeds a threshold level of video data stored. Such archiving of video data may be all video data from memory of the digital video recorder, or selected segments of video data from memory storage of the digital video recorder, where each segment is associated with a time period over which a event occurred in accordance with event video information stored in the regional database. At the master level, a master video archive server is coupled to the master server to archive video data from each of the regional video archive servers into memory storage of the master video archive server when any of the regional video archive servers exceeds a threshold level of video data stored. If all video data was archived from a digital video recorder to the regional video archive server, then such master archiving of video data may be all video data from memory of the regional video archive server to the master video archive server, or the master video archive server may select segments of video data from memory of the regional video archive server, where each segment is associated with a time period over which a event occurred in accordance with event video information stored in the regional database in the same region as the regional archive server. If only selected segments of video data was stored in memory of the regional video recorder when archived from a digital video recorder, then files storing such segments are archived from the regional video archive server to the master video archive server. Video data may also be archived from the region's digital video recorders to the master video archive server, when a regional video archive server is not available or present in the region.

When video data archived either at the regional or master level is associated with event video information (e.g., a record in the VIDEO EVENT Table) stored in the regional database, such event video information is updated to include data identifying the regional or master video archive server, respectively, containing the video data related to the event, and updated with the filename of any video data file which may have been generated storing video data related to the event. After video data is archived in a region to a regional video archive server, the archived video data original stored on the digital video recorder may be deleted. Similarly, after video data is archived at the master video archive server, the archived video data previously stored on the regional archive server may be deleted.

### BRIEF DESCRIPTION OF THE DRAWINGS

The foregoing objects, features and advantages of the invention will become more apparent from a reading of the following description in connection with the accompanying drawings, in which:

FIG. 1 is a block diagram of the system in accordance with the present invention;

FIG. 2 is a block diagram of the architecture of the regional server in each of the regions of the system of FIG. 1 providing a linkage server, communications server, and database server in the region, and shows other components or systems coupled for network data communication with the communication server;

FIG. 3 is a flow chart showing the operating of the linkage server and communications server of FIG. 2 in each of the regions for linking events with video cameras in the region;

FIG. 4 is a flow chart showing the archiving of video image data in the video archive server from one of the digital video recorders in one of the regions of FIG. 1; and

FIG. 5 is a flow chart showing the high level operation of the system of FIG. 1 at the master level; and

FIG. 6 is a flow chart showing the uploading of events and video data from one of the regional video archive servers in the regions of FIG. 1 to the master video archive server.

### DETAILED DESCRIPTION OF INVENTION

The security system of the present invention includes an access control system operating in multiple regions in which each region has one or more sites with buildings having areas in which access is controlled and monitored. Each of these regions may be a geographic region, such as cities, states, countries, or continents. In each region, card readers are associated with each area where access (entry or exit) is controlled to read information from badges worn by personnel. Information read from a badge by each card reader and other verifying information which may be provided by a cardholder to the reader, such as a pin number, is compared against stored records of a database, which may be located in a central controller, one of several access controllers, or a card reader, to determine if entry to or exit from an area is granted to the badge holder. Each region further provides badging for personnel in that badges used in the system may be added, modified or deleted. Each region in the system can operate independent of the other regions in providing badging and controlling access in accordance with a regional database for the region, while a master database provides a repository for information used by the regions in the system. The present invention is not limited to the use of any particular type of access control equipment in a region, so long as each region has a regional database which provides a repository for information used by the region.

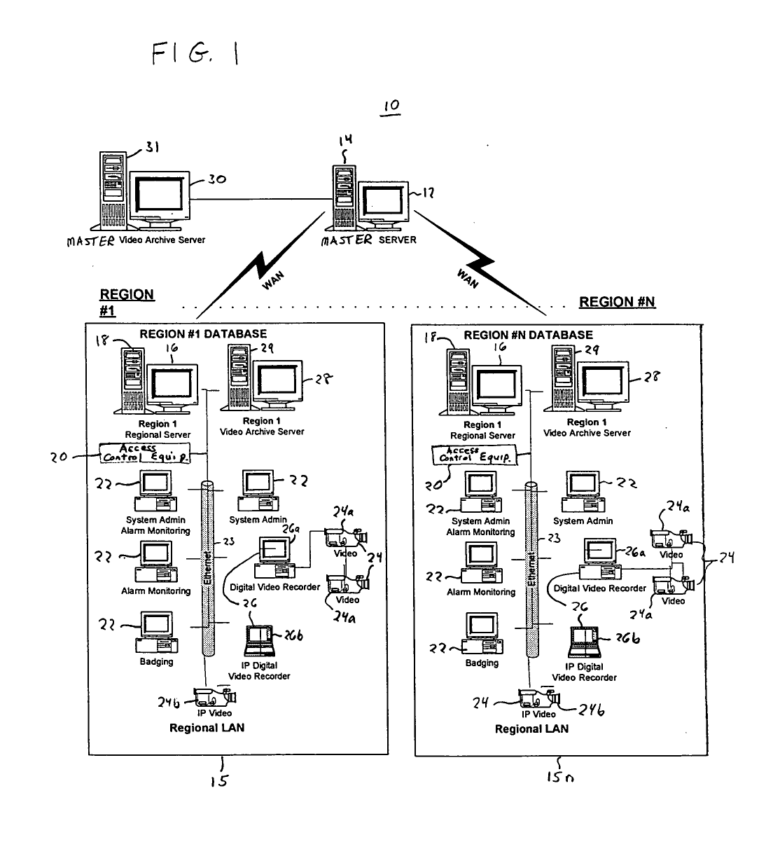

Referring to FIG. 1, the security system 10 of the present invention is shown having a master server 12 with a master database 14 at a top or master level of the system, and multiple regions 15 to 15n at a regional level of the system. Each region has a regional server 16 with a regional database 18. The master server 12 represents a computer system operating as a server in which the master database represents a memory storage unit of the master server, such as a hard drive. Each regional server 16 represents a computer system operating as a server in which its regional database 18 represents a memory storage unit of the regional server, such as a hard drive. For purposes of illustration only region #1 (denoted as numeral 15) and region #N (denoted as number 15n) are shown, where N equals the number of regions in the system.

Network communication in system 10 is provided between the master server 12 and each of the regional servers 16, and hence between their respective databases 14 and 18. The master server 12 and regional servers 16 each have communication interfaces, such as an Ethernet network card, through which such data communication can take place. The master server 12 and regional servers 16 each operate in accordance with software which can enable the transfer of data, such as files or records, between the master database 14 and regional databases 18, respectively. This software, for example, may be WindowsNT sold by Microsoft, but may be any other type of software enabling such transfer of data and files. The communication network may be WAN, Internet-based, or utilize any other type of wide area network. The communication protocol in providing network communication may be, for example, TCP/IP (Internet) protocol, or other WAN protocols may be used. Other types of communication networks may also be used, such as a telecommunication network, or LAN. The communication network in FIG. 1 is bidirectional between the master server 12 and regional servers 16. Connections between the master server 12 and each regional server 16 are established when data communication is required; however, permanent connections may alternatively be provided. The master database 14 stores configuration information for operating the system. Such information may include the unique Database ID (identifier) of each of the regional databases and of the master database in the system, or their addresses on the network. The regional database may also store regional configuration information which is needed only by the region.

In each region, the regional server 16 is coupled via a LAN 23 to access control equipment 20, such as access controllers, alarm panels, and readers. Multiple workstations 22 provide various functions in the region, such as region administration (e.g., for updating the configuration of access control equipment or access levels), alarm monitoring in the region, and badging. One or several workstations 22 may provide these functions. The workstations 22 may be connected to the regional server 16 and regional database 18 via the regional LAN 23, such by Ethernet hardware and software.

System 10 may be the same as the system described in U.S. Pat. No. 6,233,588, which is herein incorporated by reference. This patent describes the operation and interaction of the master server and regional servers and their respective databases, with improvements provided herein by the utilization of video recording in one or more regions. This patent incorporates the system of automatic downloading of information from an external database to a security system as described in U.S. patent application Ser. No. 09/135,822, filed Aug. 18, 1998, which is also incorporated herein by reference, where the master database represents a central database at the master level. Each region may similarly have its own external computer system having an external database coupled to its regional database, via its regional server, for downloading security information to the regional database, as described in this patent application, where the regional database of each region represents a central database with respect to that region. As U.S. Pat. No. 6,233,588 describes the multiregional access control features of system 10 at the master and regional levels, whereby the master database is a repository of security information for system 10, a detailed discussion of the operation of system 10 for access control and replication of information between master and regional databases is not provided herein.

To improve the system described in the above-incorporated patent, one or more regions have video cameras 24 installed in or around areas of buildings, or outside buildings, at sites in the region to view areas. Groups of one or more of the video cameras 24 are each coupled for data communication with a digital video recorder (DVR) 26 for storage of video data captured by the cameras. One or multiple digital video recorders 26 may be provided in a region. In each region, DVRs are connected to the regional server 16 of the region via LAN 23 using hardware and software appropriate for such LAN communication. DVR 26 may be of one of two types, a digital video recorder 26a for analog-based cameras, or an IP network digital video recorder 26b for digital-based cameras. Each digital video recorder 26a connects to one or more analog video cameras 24a for receiving input analog video signals from such cameras, and converting the received analog video signals into a digital format for recording on the digital storage medium of DVR 26a for storage and playback. Each IP network digital video recorder 26b connects to IP based video cameras 24b through network 23, such that the cameras produces a digital data stream which is captured and recorded within the digital storage medium of the DVR 26b for storage and playback. The digital storage medium of each DVR 26 can be either local storage memory internal to the DVR (such as a hard disk drive) and/or memory connected to the DVR (such as an external hard disk drive, Read/Write DVD, or other optical disk). Optionally, the memory storage medium of the DVR can be SAN or NAS storage that is part of the regional system infrastructure. Typically, each DVR 26a is in proximity to its associated cameras 24a such that cables from the cameras connect to inputs of the DVR, however each DVR 26b does not require to be in such proximity as the digital based cameras 24b connect over LAN 23 which lies installed in the buildings of the region. For purposes of illustration, a single DVR of each type 26a and 26b is shown in each region with one or two cameras shown coupled to the respective DVR, however the region may have one or more DVRs of the same or different type. For example, DVR 26a may represent a Lenel Digital Recorder available from Lenel Systems International, Inc., or a M-Series Digital Video Recorder sold by Loronix of Durango, Colo., DVR 26b may represent a LNL Network Recorder available from Lenel Systems International, Inc., and utilize typical techniques for video data compression and storage. However, other DVRs capable of operating over a LAN 23 may be used.

In each region, a regional video archive server 28 is connected for data communication with the regional server 16 and DVRs 26 of the region via LAN 23. The video archive server 28 represents a computer system having a memory storage unit 29 for storing video data, such as a hard drive. The regional video archive server 28 serves as a longer-term repository for video recorded by DVRs 26 that are part of the same regional infrastructure. As an example, each DVR may store up 30 days worth of video. Several DVRs may archive either all of the video or specific event video from the DVR to the regional video archive server 28 for longer term storage (e.g., greater than the referenced 30 days), as described below. Preferably, the video archive server 28 is separate computer system from the regional server 16, however, the regional video archive server may operate as part of the regional server. Although one regional video archive server 28 is shown, multiple regional video archive servers may be provided in each region each for archiving data from different groups of one or more DVRs 26 in the region.

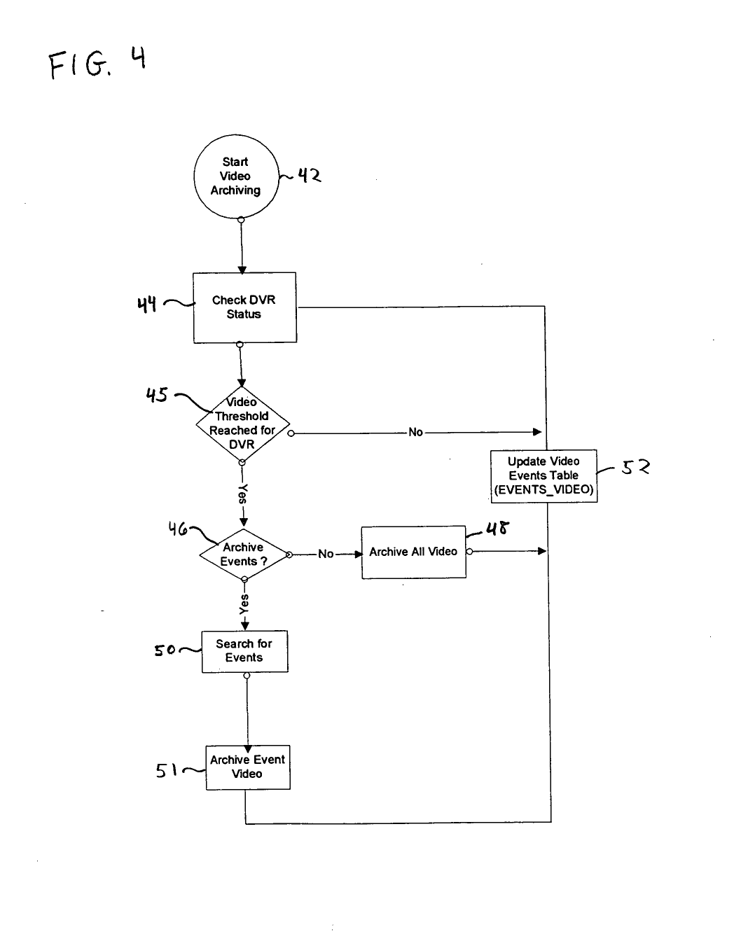

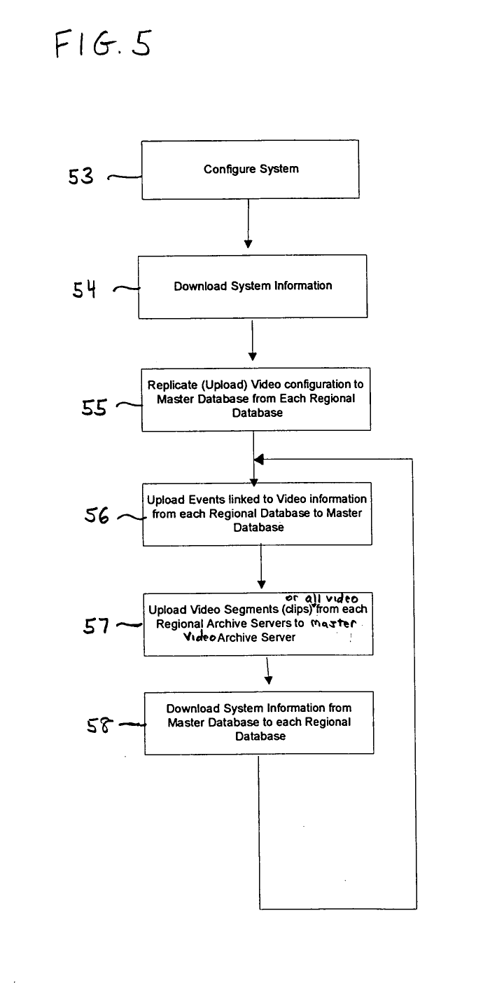

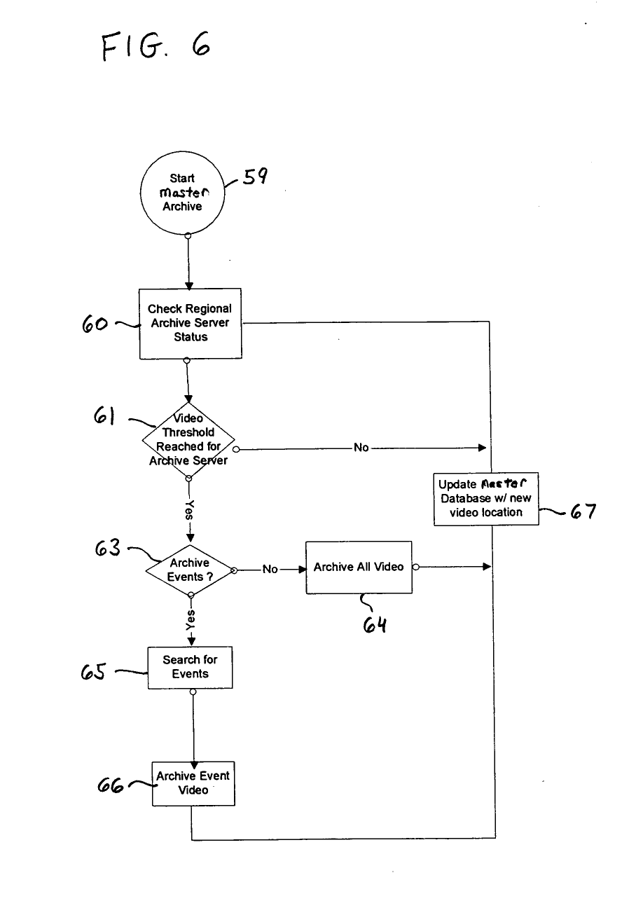

In addition to the master server 12, a master video archive server 30 is also at the master level representing a computer system having a memory storage unit 31, such as a hard drive, for storage of video data. The master video archive server 30 is a central repository for all video data from the regions. This can be all video or specified event video, as will be described below. The regional video archive servers 28 each operate independently of the master video archive servers 30, and the DVRs 26 in each region each operate independently of the regional and master video archive servers. DVRs 26 in each region archive video to the regional archive server 28, as will be described in connection with FIG. 4. All video data archived at the regional video archive server 28 is archived upwards to the master video archive server 30, as will be described later in connection with FIGS. 5 and 6. Optionally, when a regional video archive server 28 is not present or available in a region, DVRs 26 of the region may archive video directly to the master video archive server 30 similar in the manner by which such archiving would occur to a regional video archive server.

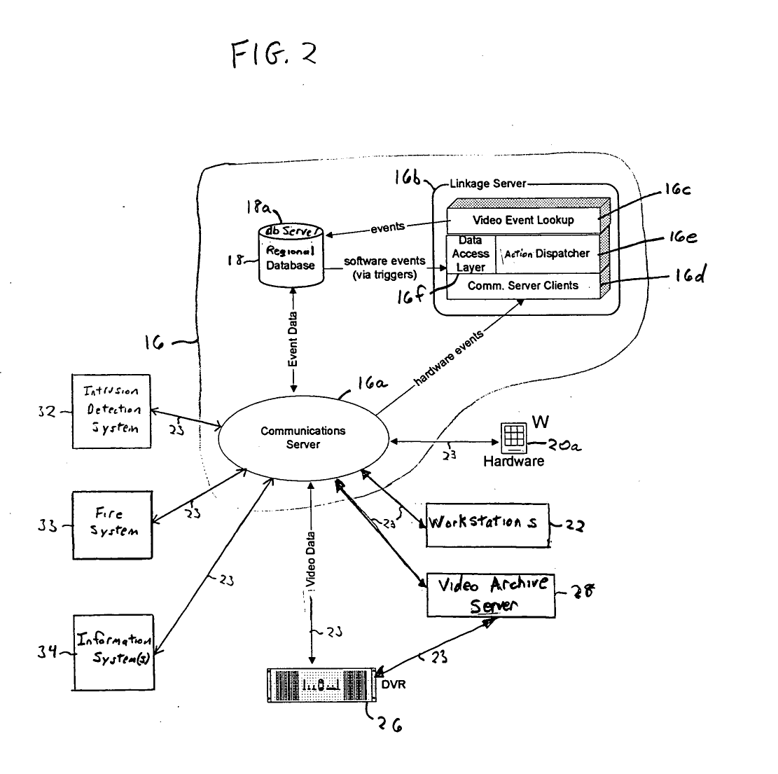

Referring to FIG. 2, the regional server 16 is shown containing three main subsystems, a communications server 16a, a linkage server 16b, and a database server 18a to the regional database 18. In each region, the database server 18a represents software (or program module) providing the storage engine upon database 18 for all of the information needed for the security system in that region. The communications server 16a represents the software (or program module) responsible for communicating with all access control hardware 20, DVRs 26, as well as workstations 22, regional archive server(s) 28, and other systems which may be present in the region, over LAN 23.

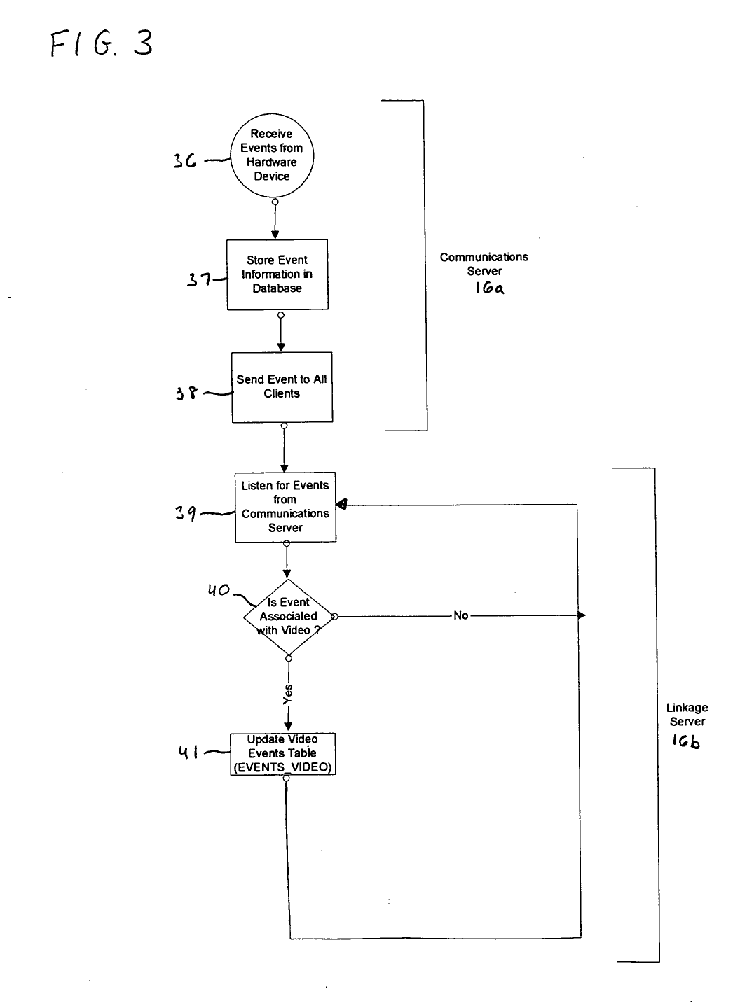

The operation of the communications server 16a is shown in the top half of FIG. 3 with respect to event data received. First, the communications server 16a receives an event (event data) sent from a hardware device 20a (such as an access control panel of equipment 20) via LAN 23 (step 36). Alternatively, the communication server 16a may poll (query command) each hardware device 20a with a command to send any accumulated events stored at the device. The communications server 16a send the event data describing the event and identifying the sending device 20as over LAN 23, to the database server 18a for storage in regional database 18 (step 37), and to any client software processes in the server 16 or external the server 16 (such as via LAN 23 to regional workstations 22) which are registered in memory of the communications server to receive the event data (step 38). Such storage of received event data may be a record in an EVENTS Table in regional database 18, which has at least data representative of the event, date and time information as to when the event occurred, and the hardware device 20a associated with the event from the received event data. Optionally, event data may also be received (or polled by communications server 16a) from other facility protection systems, such as intrusion detection (burglar) system 32, fire system 33, or from one or more information systems 34, which may be present in the region, as described in U.S. patent application Ser. No. 09/906,554, filed Jul. 16, 2001, which is herein incorporated by reference. Such systems 32-34 are IP addressable via LAN 23 as are other components on the LAN. Other facility protection systems, if present in the region, may also provide events to the regional server, such as an intercom system, personal safety alarm systems, physical asset management systems, building automation system, or other systems typically used for protection and management of personnel and property in facility environments. Event data received from systems 32-34 via communication server 16a are also be stored by the database server 18a in records of the EVENTS Table of regional database 18 with similar data to that described for identifying the sending system and/or hardware thereof associated with the event.

An example of the data fields of each record in the EVENTS Table is shown below:

EVENTS Table

SERIALNUM
EVENTIME
MACHINE
DEVID
INPUTDEVID
EVENTTYPE
EVENTID
EVENTDATA
CARDNUM
EMPID

For each record in the EVENTS Table generated in response to received event data, SERIALNUM represents a unique identifier assigned by communication server 16a for the event data received. EVENTIME represents the date and time (in hours, minutes, and seconds) from the received event data as to when the event occurred. MACHINE represents an identifier of the equipment or system from the received event data defining where the event came from, such as access control panel, controller of an intrusion detection system, controller of an fire system, information system, or a camera capable of communicating events, such as motion, or null or blocked video. DEVID represents the identifier of the subcomponent of the MACHINE related to the event from the received event data (e.g., identifier of a card reader if the event is associated with an access control event, zone identifier if the event is associated with an intrusion system, port identifier is the event is associated with an information system), or other identifier to the subcomponent of the system related to the event. INPUTDEVID represents an identifier providing additional information indicating the input port of the sending device related to the event from the received event data (e.g. if event is associated with a card reader, INPUTDEVID may represent the input number of card reader on an access control panel). If no additional information is needed to identify the part of the system related to the event, then INPUTDEVID may be a zero or a null value. EVENTTYPE represents an identifier of the type of the event from the received event data, and provides linkage to the EVENTTYPE Table described below by the EVTYPEID field of the records of this table. EVENTID represents a unique identifier for each different event of that type from the received event data. EVENTDATA represents any information further if needed to describe the event from the event data received. For example, EVENTDATA may be the text name of a fire panel input zone. However, the EVENTDATA field may be null or empty if the event is from the access control system.

If the event data is received from an access control panel of the access control system it may have additional information related to the event which may be stored in CARDNUM and EMPID field. CARDNUM represents an identifier of a card number from the received event data associated with the badge used to gain or attempt entry/exit. EMPID is an identifier associated with employee or personnel having the badge with that CARDNUM. If the event received is not related to the access control system, these two data fields would be zero or other null values.

The linkage server 16b is one of the client software processes operating on the regional server 16 that receives event data from the communications server 16a. The operation of the linkage server 16b is shown in the bottom half of FIG. 3. The linkage server first listens for events from the communications server 16a (step 39), and upon receiving event data processes it to determine if any video data is to be associated with the event (step 40). The regional database 18 has a VIDEO EVENT Table which stores records associating different events to one or more different cameras 24 in the region. An example of the data field of each record in the VIDEO EVENT Table is shown below:

VIDEO EVENT Table

EVENTID
EVTYPEID
EVID
EVDESCR
CAMERAID

EVENTID represents a unique identifier for each record of this table. EVTYPEID represents an identifier to a particular category of events, and this identifier is linked to a record of the EVENTTYPE Table described below by a field of the same name EVTYPEID. EVID represents an identifier to one of the events under this category of events. EVDESCR is a text field description of the event of that EVID. CAMERAID represents an identifier of a camera associated with the event of that EVID. CAMERAID is linked to a record of the CCTVDEVICE Table, described below, by the field CCTVDEVICEID of this table to identify the DVR for that camera and other information about the camera.

EVENTTYPE Table

EVTYPEID
EVTDESCR

EVTYPEID is an identifier for each type or category of events. For example, a type or category of events may be events from the fire system, events from an information system, or other category of events which may be grouped together as having a common attribute. EVTDESCR is a text field having a description of events of this type.

For each event received, from either access control hardware 20, or systems 32-34, the linkage server 16b has a module 16c (FIG. 2) which provides for lookup in the records of the VIDEO EVENT Table for a record having an identifier in the EVID field matching the identifier in the EVENTID field of the record recently generated by the communication server 16a in the EVENTS Table. If there is a match, the linkage server 16b generates and adds (updates or stores) a record in an EVENTS VIDEO Table of the regional database 18 with event video information linking the event received with information for locating stored video data relevant to that event. An example of the data fields of each record in the EVENTS VIDEO Table is shown below:

EVENTS VIDEO Table

SERIALNUM
MACHINE
VIDEOSERVERID
CAMERAID
STARTTIME
ENDTIME
ARCHIVELOCATIONID
ARCHIVEFILE
PURGED

For each record in the VIDEO EVENT Table having an EVENTID field matching the EVENTID of a record of the EVENTS Table, a record in the EVENTS VIDEO Table is generated having the following. SERIALNUM is set to the identifier for the event provided from the SERIALNUM field of the record for the event in the EVENTS Table. Similarly, MACHINE is set to the identifier of the equipment or system which sent the event as provided from the MACHINE field of the record of the event in the EVENTS Table. VIDEOSERVERID represents a unique identifier of a DVR having the video data stored related to the event, and CAMERAID represents a unique identifier of a camera associated with that DVR. The entry in the VIDEOSERVERID field is provided by a record from the PANELID field of a record in the CCTVDEVICE Table, shown below, linked by CAMERAID, which is provided by the identifier in the CAMERAID field of the record of the VIDEO EVENT Table. Each camera and DVR has a unique identifier in each region of the system 10.

STARTTIME and ENDTIME are a start date and time and an end date and time, respectively, determined by linkage server 16b for identifying the relevant video data for the event on at the DVR identifier entered in the VIDEOSERVERID field. The STARTTIME is determined based upon the EVENTIME field of the record for the event in the EVENTS TABLE minus a PREROLL time value provided from a record of the CCTVDEVICE Table for the camera as linked by CAMERAID. ENDTIME is determined based upon the EVENTIME field of the record for the event in the EVENTS Table plus a POSTROLL time value provided from a record of the CCTVDEVICE Table for the camera as linked by CAMERAID. For example, if the EVENTIME was Jan. 1, 2003, at 10:00:30 AM, and POSTROLL and PREROLL are both 20 seconds, then STARTIME is Jan. 1, 2003 at 10:00:10, and ENDTIME is Jan. 1, 2003 at 10:00:50 AM.

The master video archive server 20 and each of the regional video archive servers 28 have a unique identifier or address in system 10. ARCHIVELOCATIONID represents a unique identifier of an archive server where video data is stored after it is archived. ARCHIVEFILE is the file name on video archive server (one of a regional video archive server or master video archive server) having that video data. The file name assigned by such video archive server may be determined based on start (or end) date and time of video recorded, or other value such that the stored files may be searchable chronologically. Until video data is archived, the valued of ARCHIVELOCATIONID and ARCHIVEFILE are zero or null. PURGED is a flag (“yes” or “no”) indicating whether the video data related to the event has been removed from the DVR of the VIDEOSERVERID field of the record. Typically, this is set to “no” until after video data related to the event has been archived.

To store attributes about each camera of a region, data is stored in a record of a CCTVDEVICE Table. For example, the data fields of this table may be as described below:

CCTVDEVICE Table

CCTVDEVICEID
PANELID
DEVICETYPE
NAME
CHANNEL
INTRAFRAMERATE
FRAMERATE
BRIGHTNESS
CONTRAST
COLOR
HUE
PREROLL
POSTROLL

In each record of this table, CCTVDEVICEID represents an identifier of a camera. PANELID is the identifier of the DVR which stores video data captured from that camera. DEVICETYPE is an identifier or text describing the type of camera, such as analog or digital. NAME is a text field having the make or model of the camera. CHANNEL is an optional field which may be used when the camera has different operating channels. INTRAFRAMERATE represents a time value indicating how often a base frame is taken by the camera, such as when the camera images utilizing MPPEG4 or other imaging protocol requiring such information. The FRAMERATE, BRIGHTNESS, CONTRAST, COLOR, and HUE, are all numeric fields describing different camera imaging parameters. The regional server in each region may automatically setup the camera in each region by setting of these parameters. As stated earlier, PREROLL represent the amount of time to subtract from an event time to determine start time of video data relevant to an event, and POSTROLL represent the amount of time to add from an event time to determine end time of video data relevant to an event. A Hardware Table is also provided having a record for each device, MACHINE, VIDEOSERVERID, or PANELID, in the system 10. Such fields in the Hardware Table may include field having a text field with the name of the device or system, or parameters for communication with the device or system. Other tables and records may also be included in the regional server as described in above-incorporated U.S. Pat. No. 6,235,588, and patent application Ser. Nos. 09/135,822 or 09/906,554. Although the above data structures are described, the system is not limited to such data structures as different data structures may be used having similar information.

If no entry is found for the event in the VIDEO EVENT Table (step 40 of FIG. 3), the event is discarded and the linkage server 16b returns to step 39 to listen for the next event. If multiple events are received at the same time, they are queued for processing by the linkage server 16b, or multiple instances of the linkage server may be provided in the regional server for parallel processing of events. In this manner, if video is to be associated with the event, an entry is marked within the regional database showing this relationship. Once the video is marked in the VIDEO EVENT Table, the client software, such as at workstations 22, can automatically find and playback this video information by identifying the video data storage device (e.g., VIDEOSERVERID or ARCHIVELOCATIONID) with such information and using the date and time information (STARTTIME and ENDTIME) to index the video on that device to the relevant period of time when the event occurred.

Referring back to FIG. 2, the linkage server 16b also has software process or module 16d representing a software interface for receiving event data from the communications server 16a, such as may be sent at step 38. The linkage server may include an action dispatcher 16e representing the event transaction processor described in the incorporated U.S. patent application Ser. No. 09/906,554 to enable actions to be automatically taken action in response to events representing a security risk. For example, such actions may be to commands to instruct a camera 24 to change its frame rate to a higher rate, e.g., from 2 to 30 frame/sec, to capture more video data. Events may also be received, via the communications server 16a, directly from cameras 24 which have motion detection capability or when video data (frame) is null, i.e., blocked or zero signal received. The data access layer 16f represents a software process or module to enable the linkage server to query the database 18 via the database server 18a for information, such as to search records of tables stored in the database. Also, software events can occur in the regional database when information is updated in the regional database, such as employee or badge information, such as described in incorporated of U.S. application Ser. No. 09/135,822, which can effect security in the system and cause a trigger or response in the linkage server. For example, software events may be linked to cameras via the EVENTS VIDEO Table and/or require action to be taken as instructed by the action dispatcher 16e.

Referring to FIG. 4, the archiving process is shown which is performed in each region by each regional video archive server 28 for the DVR(s) in the region which are associated with that archive server. The regional video archive server 28 performs the process periodically, such as once a day, for each DVR 26 associated with that archive server, or other time period as defined in memory (such as a record or file) of the regional database 18 of regional server 16 of the region. When the archiving time period has expired, archiving process starts (step 42).

If more than one regional video archive server 28 is present in a region, then the regional server 16 has a table in memory of database 18 associating each DVR with one of the regional video archive servers. The regional video archive server can use entries or records of this table to determine the DVR(s) of the region upon which to perform the regional archiving process. For example, a regional video archive server can determine which DVR(s) of the region are associated (or registered) to it by querying records of the HARDWARE Table for DVRs which may have a field with the name of the regional video archive server to archive its video. Communication between the regional video archive server 28 and a DVR are in accordance with the command set and data structures for the particular DVR over a LAN 23.

The regional video archive server 28 next checks the status of a DVR 26 associated with that archive server (step 44). This may be performed by the regional video archive server 28 querying the DVR for this information, and receiving a number representing how much memory of the DVR is full in terms of number of bytes stored. Video data in memory of the DVR is stored until a user-defined threshold is reached (step 45). This threshold is a variable set in memory of the regional database 18 of the regional server 16, and may vary by DVR if different DVRs have different memory capacities. The threshold can be set in terms of the amount of bytes of video data stored in the DVR's memory. Alternatively, the DVR may return a percentage of its memory full, such that when the regional video archive server receives the percentage it compares it a user-defined percentage threshold. For example, the threshold may be 60%, or if amount of bytes stored are used, a value equal to 60% of the memory capacity of the DVR. If the threshold is not reached, the regional video archive server 28 checks the next DVR 26 registered to it in the region (step 44). If the threshold of a DVR 26 is reached (step 45), the regional video archive server checks if all the video data stored should be archived, or only such video data associated with events (step 46). If all video is to be archived, the regional video archive server 28 instructs the DVR to transfer (or download) video data from the DVR's memory and store the video data in memory 29 of the regional video archive server. Such video data is stored while maintaining the date and time (hours, minute, seconds) by which such video data is indexed, and the source (i.e., camera) of the video data. If all video data is transferred from the DVR to the regional video archive server, the file(s) having such video data may be organized in the video archive server's memory in the same manner as they were stored in the DVR. For example, when all the video from the DVR is archived, a new record is generated by the video archive server in the EVENTS VIDEO table for each camera associated with the DVR at the time of transfer, which has null SERIALNUM and MACHINE fields (as the record is not related to a particular event), a VIDEOSERVERID field set to the DVR, a CAMERAID field set for the particular camera the record pertains to, STARTTIME and ENDTIME fields for the start and end date and time, respectively, for the video data transferred, a ARCHIVELOCATIONID field set to the regional video archive server storing the video data transferred, and a ARCHIVEFILE having the filename of the file on that server containing the transferred video data. The video transferred is stored in a file under a file name generated by the regional video archive server based on the STARTTIME and ENDTIME of the video data. Optionally, such file name may include additional identifying information of the DVR and/or camera.

If at step 46 the regional server 16 is set to record only selected events for that DVR, rather than all of its stored video, the regional video archive server 28 queries the DVR for the date and time of the earliest and the latest video data stored in memory of the DVR to determine the time period covering such stored video. Next, the regional video archive server 28 searches the EVENTS VIDEO Table of the regional database 18 for any records having VIDEOSERVERID field matching that of the identifier for the DVR and having either a STARTIME or ENDTIME within the determined time period of the stored video on the DVR (step 50). For each record found matching these criteria, the regional video archive server 28 instructs the DVR to transfer (or download) that segment of video data stored on the DVR beginning at an index at the STARTTIME and stopping at the index at the ENDTIME. Video data stored is indexed in the DVR's memory by date and time of capture. The transferred video data thus represents a selected video clip from the DVR stored now on the regional video archive server 28 (step 51). The video clip is stored in a file under a file name generated by the regional video archive server based on the STARTTIME and ENDTIME of the video data. Optionally, such file name may include additional identifying information of the DVR, and/or camera, and/or event serial number.

When the video is archived at step 48 or 51, the ARCHIVELOCATIONID field of the record of the EVENTS VIDEO table of the regional database 18, associated with the recently archived video data, is updated with an identifier for the regional video archive server having the archived video data, and the ARCHIVEFILE is set to the filename of the file having the archived video data on the regional video archive server (step 52). This may be achieved by the regional video archive server searching the EVENTS VIDEO Table of the regional database 18 for any records having VIDEOSERVERID associated with the identifier of that DVR and having STARTTIME or ENDTIME within the period of the archived video data, and updating the ARCHIVELOCATIONID and ARCHIVEFILE appropriately. Once this update of the EVENTS VIDEO table is complete, the regional video archive server instructs the DVR to delete in its memory video data over the overall start and end time period of the original video data which was archived from the DVR, and the PURGE field of the record of the EVENTS VIDEO Table of the database 18 associated with the recently archived video data is set to yes. In this manner, all video that is archived is marked in the regional database so that clients to the regional server can locate the video data at the new storage location when playback is desired, and additional capacity is provided at the DVR for new video data to be stored. After the regional archiving process is complete for the DVR, the regional video archive server 28 then checks the status of the next DVR at step 44 and performs steps 45-52 when the threshold memory storage capacity of the DVR is exceeded, as described above.

As described in the above-incorporated U.S. patent, access control information from each region is uploaded periodically from the regional database 18 of the regional server 16 to the master database 14 of the master server 12. Such access control information uploaded from each region in system 10 also includes records of tables of the region needed by the master server for accessing video data, such as EVENT, VIDEO EVENT, and EVENTS VIDEO Tables. Thus, any new or updated records in such tables are periodically automatically uploaded to the master database 14.

Referring to FIG. 5, a high-level flow chart of the master to regional video archival process is shown. For each region of system 10, the system is configured (step 53) at the master server 12 and system information downloaded (step 54) from the master database of the master server to each of regional databases as described in the above incorporated U.S. patent. Security information stored in the master database includes system information which represents information which is uniform at each region's regional database. The system information includes tables defining system wide information and the records contained therein, such as general information about the sites, building, and regions of the system. The system information also includes information for establishing network connections and data communication via such connections, and the layouts (i.e., data fields) of all the tables in which records of information are to be stored.

Next, video configuration is replicated (uploaded) to the master database from each of the regional databases (step 55). Video configuration information represents unique identifiers used by each of the regions representing the regional video archive servers, and the DVRs and cameras of the region. The upload of video configuration information is performed periodically from the regional database of each region to the master server to assure that the master database maintains the most current version of such information. Events linked to video information, as provided by records of EVENTS VIDEO table, are uploaded from each regional database to the master database via the master and regional servers (step 56). Video segments or all video from memory of each regional archive server is uploaded to the master video archive server, as described below in connection with FIG. 6 (step 57), and any system information that has changed is downloaded by the master server from the master database to each regional database (step 58).

Referring to FIG. 6, the archiving process from each region to the master video archive server 30 is shown in more detail. The archiving process is similar to that of FIG. 4, except the archiving process is between the master video archive server and each of the regional video archive servers, rather than between a regional video archive server and a DVR. For each regional video archive server in system 10, periodically, such as once a day, or other time period as defined in memory of the server 12 or 30, the master video archive server 30 starts the master archiving process (step 59) by checking the status of the regional video archive server by determining whether the regional video archive server has reaches its threshold memory capacity (step 60). The video configuration information for the region stored in the master database is used to determine the identifiers by which each regional video archive server of a region may be addressed. Step 60 may be achieved by the master video archive server 30 querying the regional video archive server 28 for the number of bytes of stored on its memory storing archived video data, and comparing it to the threshold memory capacity (step 61). Such returned values and threshold may alternatively be in terms of percentages of memory full. If the regional video archive server 28 has exceeded this threshold, a check is made whether to archive all video data or event based video (step 63). If all video data is to be archived; then all video data file or files in memory 29 of the regional video archive server 28 are transferred to memory 31 of the master video archive server 30 (step 64). If the master server is set to record only selected events for that regional video archive server, the master video archive server searches the EVENTS VIDEO Table of the master database having the replicated version of the records from the regional database 18 for records having non-null SERIALNUM and/or MACHINE fields, a ARCHIVELOCATIONID field with an identifier for the regional video archive server, and a STARTTIME and ENDTIME for the earliest and latest video data stored in its memory of the regional video archive server as may be determined by analysis of the files on the regional video archive server (step 65). For each record found, the file having that filename of the ARCHIVEFILE field of the record is uploaded to memory 31 of the master video archive server (step 66). If a null SERIALNUM and/or MACHINE fields record is found having a ARCHIVELOCATIONID field with an identifier for the regional video archive server, and has a STARTTIME and ENDTIME falling within the earliest and latest video data stored in its memory of the regional video archive server, then the master video archive server 30 transfers video segments selected from the video data stored in the file having the filename of the ARCHIVEFILE field of the record from memory 29 of the regional video archive server 28 similar in the manner as such video segments are selected from DVR memory at a regional level performed at steps 50 and 51 of FIG. 4.

When the video is archived at step 64 or 66, the record of the EVENTS VIDEO table of the master database 14 and the regional database 18 for the region having the regional video archive server, which is associated with the recently archived the ARCHIVELOCATIONID field, is updated by the master video archive server with the identifier associated with the master video archive server, and if video was archived by the master video archive server by event and was not previously archived at the regional level by event, the ARCHIVEFILE field is set to the filename of the file having the archived video segment in memory 31 of the master video archive server 30 (step 67). Once this update of the EVENTS VIDEO Table is complete, the master video archive server 30 instructs the regional video archive server 28 to delete in its memory such video data over the overall start and end time period of the video data which was archived from the regional video archive server 28 to the master video archive server 30, and the PURGE field of the record of the EVENTS VIDEO Table of the regional database 18 and the master database 14 associated with the recently archived video data is set to yes. Optionally, the update to the master database may occur by the next upload of the EVENTS VIDEO table for that region to the master database, rather immediately after at the video data is archived. Again, in this manner all video that is archived is marked in the database so that clients to the master or regional server can locate the video data at the new storage location when playback occurs. After the master archiving process is complete for the regional video archive server, the master video archive server 30 then checks the status of the next regional video archive server at step 60 and performs steps 61-67 when the threshold memory storage capacity of the regional video archive server is exceeded, as described above.

If a region does not have a regional video archive server 28, the DVR(s) of the region are set in the master server in the video configuration information as the regional video archive server, such that the DVRs are addressed rather than a regional video archive server when archiving is performed by the master video archive server 30.

Thus, events occurring in each region are linked to video captured in the region, and the archival process assures that such linked video captured is maintained first at the DVR level, then at the regional level of a regional video archive server, and eventually at the master level of the master video archive server. This provides a convenient and efficient method for event lookup and retrieval by workstations which may be connected over the network by searching the records of the EVENTS VIDEO table for each of the regions at either the master or regional database, and accessing the video data stored at the video storage device for covering the relevant date and time in the records. Archiving of video data relevant to events provides a filtering or thinning of video data, and thus more efficient archival storage of video information for use for security in the regions.

Optionally, forensic information (such as individual images) within the event may be produced when video data is archived to a regional video archive server or master video archive server along with additional textual information. Also, face recognition software could be employed at video data stored at a regional or master video archive server to automatically compare stored facial information for the person having access to an area with video captured by a camera at a card reader or other access or entry/exit point of a building.

From the foregoing description, it will be apparent that there has been provided a system multiregional security system integrated with digital video recording and archiving. Variations and modifications in the herein described system and methods employed by such system in accordance with the invention will undoubtedly suggest themselves to those skilled in the art. Accordingly, the foregoing description should be taken as illustrative and not in a limiting sense.

1. A security system in multiple geographic regions each having one or more facility protection systems, said security system comprising:
a master server;
each of the regions having at least one regional server with a regional database, one or more cameras for capturing video data, and one more video recorders for storing video data from the cameras;
said regional server of each of said regions being coupled for data communication to one or more facility protection systems of the region for receiving event data from said systems having information describing events occurring in the region;
said regional database of each of the regions having first information associating different events to different cameras in the region;
said regional server of each of said regions comprising means for generating second information linking events received by the regional server with video data stored on one of the video recorders and camera in accordance with said first information of said regional database;
at least one regional video archive server in each region for archiving video data from the video recorders of the region; and
a master video archive server coupled to the master server for archiving video data from the regional video archive server in each of the regions, in which said second information is updated with data identifying which one of said regional or master video archive servers when archived video data is associated with said second information.

2. The security system according to claim 1 further comprising means for archiving at the regional video archive server segments of video data linked to events in accordance with said second information.

3. The security system according to claim 1 further comprising means for archiving at the master video archive server segments of video data linked to events in accordance with said second information.

4. The security system according to claim 1 wherein second information further comprises data at least representative of the event, the camera linked to the event, the digital video recorder storing video data from the linked camera, and date and time information related to a period of time over which the event occurred.

5. The security system according to claim 1 wherein one or more of said cameras represents digital-based cameras and one or more of said camera represents IP network digital recorders for receiving video data from said cameras.

6. The security system according to claim 1 wherein one or more of said cameras represent analog-based cameras and one or more of said camera represent digital recorders for receiving analog video data from said analog-based camera, and converting said analog video data into digital video data for storage on said digital recorders.

7. The security system according to claim 1 wherein said regional video archive server in each region periodically archives video data from each of the video recorders of the region when the video recorders stores video data exceeding a threshold level.

8. The security system according to claim 1 wherein said master video archive server periodically archives video data from each of the regional video archive servers when the video data storage on said regional video archive server exceeds a threshold level.

9. The security system according to claim 1 wherein said regional server of each of said regions is coupled to one or more information systems of the region for receiving event data from said information systems.

10. A security system in multiple geographic regions comprising:
a plurality of regions in which each region has an access control system having a regional server with a regional database storing information for access control in the region, one or more cameras for capturing video data, and one more digital video recorders for storing video data from the cameras;
said regional server in each region having means for receiving events from one or more of an access control system, intrusion detection system, fire system, or information systems;
said regional database in each region stores linking information representing data associating different ones of said events to cameras in the region; and
said regional server in each region having means responsive to receiving one of said events linked to a camera of the region for storing event video information in said regional database for said regional server having data associating the event with the linked camera, in accordance with said linking information in said regional database for said regional server, with data representing a video data storage device for the linked camera, and date and time information related to when the event occurred by which the relevant video data for the event is locatable at the video data storage device.

11. The security system according to claim 10 further comprising:
a video archive server in each region having memory for storing video data; and
means in each region for transferring video data recorded by the digital video recorders in the region to the video archive server, and updating the event video information in said regional database for said regional server related to the transferred video data to indicate the video archive server storing said archived video data.

12. The security system according to claim 10 further comprising:
a master server having a master database storing information for access control in each of the regions, a master video archive server coupled to said master server having memory for storing video data; and
means for uploading video data from the video archive server of each of the regions into the memory of said master video archive server, and event video information to the master database, and updating the event video information in said regional database for said regional server related to the transferred video data to indicate the master video archive server as storing said archived video data.

13. A system for linking video to events occurring in at an access control system comprising:
one or more cameras for capturing video data, and means for digitally recording video data from different groups of said cameras;
a computer system coupled to at least an access control system for receiving event data from said systems having information about events and when events occurred;
a database coupled to said computer system having first information associating different events to different cameras in the region; and
said computer system comprising means for generating second information linking event data received with the camera and the digital recording means storing video data from said camera in accordance with said first information.

14. The system according to claim 13 further comprising means for archiving video data from said digital recording means.

15. The system according to claim 13 wherein said events are received by said computer system are from one of an intrusion detection system, fire system, or information system.

16. A security system in multiple geographic regions each having one or more facility protection systems, said security system comprising:
a master server;
each of the regions having a regional server with a regional database, one or more cameras for capturing video data, and one more video recorders for storing video data from the cameras;
said regional server of each of said regions being coupled to one or more facility protection systems of the region for receiving event data from said systems having information about events occurring in the region;
said regional database of each of the regions having first information associating different events to different cameras in the region;
said regional server of each of said regions comprising means for generating second information linking events received by the regional server with the location of video data stored on video recorders captured by cameras relevant to the event in accordance with said first information when said events are associated with said different cameras in said regional database; and
a master video archive server coupled to the master server to archive video data from at least one video recorder in one of the regions.

17. A method for archiving video data captured in multiple geographic regions having one or more facility protection systems comprising the steps of:
providing in each of the regions having a regional server with a regional database, one or more cameras for capturing video data, and one more video recorders for storing video data from the cameras;
receiving event data at the regional server from one or more facility protection systems of the region having information about events occurring in the region;
associating in said regional database different events with different cameras and their associated video recorders;
generating information linking events received by the regional server with video data stored on one of the video recorders and camera in accordance with said first information of said regional database;
archiving video data from the video recorders in each region to at least one regional video archive server in the region;
updating said information linking event with video data to indicate the regional archive server having the linked video data;
archiving video data from the regional video archive server in each region to a master video archive server; and
updating said information linking events with video data to indicated the master archive server as having the linked video data.

18. The method according to claim 17 wherein said video data is archived periodically from the video recorders in each region to at least one regional video archive server in the region when the video data stored on said video recorders exceeds a threshold level.

19. The method according to claim 17 wherein said video data is archived periodically from the regional video archive servers to the master video archive server when the video data stored on said regional video archive server exceeds a threshold level.
